(19) United States
(12) Patent Application Publication
(10) Pub. No.: US 2023/0078096 A1
(43) Pub. Date: Mar. 16, 2023

(54) OFFLINE DELEGATION OF AUTHORIZATION DATA

(71) Applicant: ASSA ABLOY AB, Stockholm (SE)

(72) Inventor: Martin Kaufmann, Graz (AT)

(21) Appl. No.: 17/447,317

(22) Filed: Sep. 10, 2021

(51) Int. Cl. G06F 21/35; H04L 9/32

(52) U.S. Cl. CPC G06F 21/35; H04L 9/3247; H04L 9/3263

(57) ABSTRACT

A method for offline delegation of authorization to access a secure asset. The method comprises receiving an offline delegation request from a delegating device at a receiving device while the receiving device is not in communication with a server of an authorization management system, the offline delegation request indicating a delegation of authorization from the delegating device to the receiving device for access to a secure asset; after establishing communication with the server, transmitting the offline delegation request from the receiving device to the server; and receiving, at the receiving device, authorization data from the server in exchange for the offline delegation request, the authorization data permitting access to the secure asset by the receiving device; wherein the offline delegation request comprises an identity of the receiving device or user of the receiving device and is digitally signed by the delegating device.

### TECHNICAL FIELD

Embodiments described herein generally relate to the delegation of authorization data in authorization management systems.

### BACKGROUND

In authorization management systems, users may delegate authorization to other users within the system to, for example but not limited to, access a physical or logical secure asset or resource, such as a doorway or building area (e.g. a physical secure asset) or an application, database, or financial account (e.g., a logical secure resource). For example, an employer (or an employee of the employer, such as a manager or supervisor) may delegate authorization to one or more other users employed by the employer (such as those managed by the manager or supervisor), providing authorization for the other users to, for example, access a corresponding secure asset or resource. In authorization management systems in contactless infrastructures, authorization may be delegated through a fairly straightforward process. A device of a first user (the delegator) having the appropriate authorization (and the right to delegate) may communicate with a server of the authorization management system over a network to designate or approve delegation of the authorization or authorization data to a second user (the delegate). A device of the second user may then communicate with the server over a network to generally immediately obtain the appropriate authorization data, typically in the form of an authorization certificate or token, which may then be used by the second user to access a corresponding secure asset or resource.

However, an issue arises when the device of the first user and/or the device of the second user do not have access to the server at the time of delegation (i.e., either the device of the first user and/or the device of the second user are offline at the moment). Accordingly, there is a need in the art for improved systems and methods for offline delegation of authorization.

### BRIEF SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a method for offline delegation of authorization to access a secure asset. The method comprises receiving an offline delegation request from a delegating device at a receiving device while the receiving device is not in communication with a server of an authorization management system, the offline delegation request indicating a delegation of authorization from the delegating device to the receiving device for access to a secure asset; after establishing communication with the server, transmitting the offline delegation request from the receiving device to the server; and receiving, at the receiving device, authorization data from the server in exchange for the offline delegation request, the authorization data permitting access to the secure asset by the receiving device; wherein the offline delegation request comprises an identity of the receiving device or user of the receiving device and is digitally signed by the delegating device.

The present disclosure, in one or more embodiments, additionally relates to a method for offline delegation of authorization to access a secure asset. The method comprises receiving an offline delegation request from a receiving device at a server of an authorization management system, the offline delegation request having been received by the receiving device from a delegating device while the receiving device was offline from the server, wherein the offline delegation request comprises an identity of the receiving device or user of the receiving device and is digitally signed by the delegating device, and wherein the offline delegation request indicates a delegation of authorization from the delegating device to the receiving device for access to a secure asset; validating the offline delegation request by validating the signature of the delegating device; and if the signature of the delegating device is valid, transmitting authorization data from the server to the receiving device, the authorization data permitting access to the secure asset by the receiving device.

The present disclosure, in one or more embodiments, additionally relates to a non-transitory computer readable medium comprising executable program code, that when executed by one or more processors, causes the one or more processors to: receive an offline delegation request from a delegating device at a receiving device while the receiving device is not in communication with a server of an authorization management system, the offline delegation request indicating a delegation of authorization from the delegating device to the receiving device for access to a secure asset; after establishing communication with the server, transmit the offline delegation request from the receiving device to the server; and receive, at the receiving device, authorization data from the server in exchange for the offline delegation request, the authorization data permitting access to the secure asset by the receiving device; wherein the offline delegation request comprises an identity of the receiving device or user of the receiving device and is digitally signed by the delegating device.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the scope of the present disclosure. Accordingly, the drawings and detailed description are to be regarded as illustrative in nature and not restrictive.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an example authorization management system for offline delegation of authorization data;

FIG. 2 illustrates another authorization management system for offline delegation of authorization data;

FIG. 3 is a flow chart generally illustrating a method for offline delegation of authorization data; and

FIG. 4 illustrates a block diagram schematic of various example components of an example machine that may be used as, for example, a delegating device, receiving device, server, or reader/terminal device.

### DETAILED DESCRIPTION

The present disclosure generally relates to the delegation of authorization data in authorization management systems. More particularly, the present disclosure relates to the offline delegation of authorization data in authorization management systems. In general, offline delegation of authorization data, as described herein, is designed to permit users to delegate authorization to other users within an authorization management system to, for example but not limited to, access a physical or logical secure asset or resource, even in instances where either the delegating user or receiving user are initially “offline” from the server of the authorization management system.

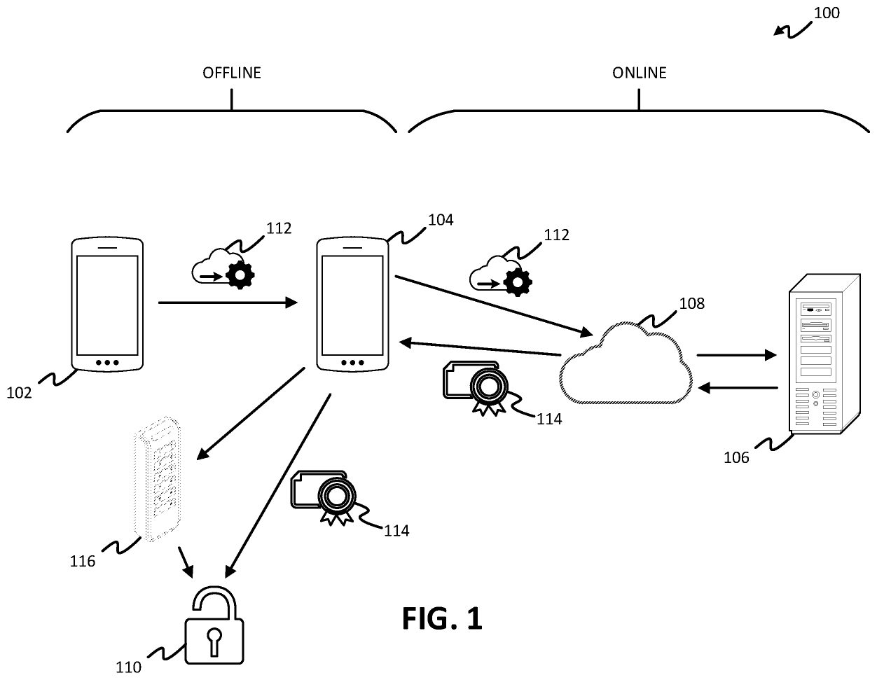

FIG. 1 illustrates an example authorization management system 100 for offline delegation of authorization data. Delegating device 102 may be a device of a first user having or owning an authorization to, for example but not limited to, access a physical or logical secure asset or resource, such as a doorway or building area (e.g. a physical secure asset) or an application, database, or financial account (e.g., a logical secure resource). The first user may alternatively or additionally have the right to delegate such authorization to other approved users. Receiving device 104 may be a device of a second user to which the first user desires to delegate authorization. Server 106 may be a device of the authorization management system 100 that, among other things, receives requests for delegation of authorization, validates and/or approves such delegation requests, and provides the appropriate authorization data to corresponding delegated devices. Delegating device 102 or the user of the delegating device, and authorization rights and/or delegation rights owned thereby, are known to server 106. Receiving device 104 (and optionally delegating device 102), when “online” with server 106, may communicate with the server via network 108. Example networks suitable for network 108 can include a local area network (LAN), wide area network (WAN), packet data network (e.g., the Internet), mobile telephone network (e.g., cellular network), Plain Old Telephone (POTS) network, wireless data network (e.g., IEEE 802.11 family of standards known as Wi-Fi or IEEE 802.16 family of standards known as WiMax), IEEE 802.15.4 family of standards, and/or peer-to-peer (P2P) network, among others. Secure asset 110 may be any physical or logical asset or resource for which appropriate authorization data is required in order for the user or user device to access the asset or resource to, for example, perform one or more operations with respect to the asset or resource.

In the authorization management system 100 of FIG. 1, either or both of delegating device 102 or receiving device 104 may initially be “offline,” in that either or both of delegating device 102 or receiving device 104 are not in communication with, or do not desire to or are unable to communicate with, server 106 directly or indirectly, such as via network 108. However, the user of delegating device 102 desires to delegate authorization to the user of the receiving device in order to permit the user of receiving device 104 to access secure asset 110.

Accordingly, in an example of offline delegation of authorization data herein, delegating device 102 may generate an offline delegation request 112 and transmit the offline delegation request to receiving device 104. Offline delegation request 112 comprises an identity or identifier of receiving device 104 or user of the receiving device. The identity of receiving device 104 or user of the receiving device can be, for example, a public key of the receiving device or user of the receiving device. However, the identity of receiving device 104 or user of the receiving device may be any other suitable identifier of the receiving device or user of the receiving device, such as but not limited to, a public key certificate, which may be a public key signed by a certification authority. The identity of receiving device 104 or user of the receiving device binds offline delegation request 112 to the receiving device or user of the receiving device. Offline delegation request 112 may further include any other suitable or desirable information or data, such as but not limited to information or data indicating which secure asset 110 or secure assets the offline delegation request pertains to and/or which operation or operations corresponding to the secure asset(s) are requested to be delegated to receiving device 104 or user of the receiving device, etc. Offline delegation request 112 is digitally signed (e.g., using asymmetric cryptography) by delegating device 102. Because delegating device 102 or the user of the delegating device is known to server 106, the server can validate or trust any delegation request signed by the delegating device. Offline delegation request 112 may be encrypted and transmitted to receiving device 104, or the offline delegation request may be transmitted to the receiving device unencrypted, e.g., in plain text, depending on the privacy protection desired or required. In an example, offline delegation request 112 may be encrypted using an attribute-based cryptography algorithm. However, any encryption or cryptography algorithm may be used for encrypting offline delegation request 112. In an example, only server 106 is able to decrypt offline delegation request 112. That is, in such example, receiving device 104, or any other device, such as any intermediate interceptors, are generally not able to decrypt, or at least efficiently decrypt, the encrypted offline delegation request 112. In an example, offline delegation request 112 may be transmitted to receiving device 104 using a secure messaging channel. Any method for creating a secure messaging channel between delegating device 102 and receiving device 104 may be used, including, for example, the method for creating a secure messaging channel described in copending U.S. patent application Ser. No. 17/447,310, titled “Fast Bilateral Key Confirmation,” filed Sep. 10, 2021, and identifiable by attorney docket no. 5483.633US1, which is incorporated herein by reference in its entirety.

Receiving device 104 is not able to utilize the offline delegation request 112 to access secure asset 110. Rather, receiving device 104 communicates with server 106 to, generally, exchange offline delegation request 112 for appropriate authorization data 114 required to access secure asset 110. If at the time of receiving offline delegation request 112 from delegating device 102, receiving device 104 is offline or otherwise does not desire to or is unable to communicate with server 106 directly or indirectly, such as via network 108, the receiving device can wait to communicate with the server until the receiving device is online or otherwise able to communicate with the server directly or indirectly, such as via network 108. Once receiving device 104 is online or otherwise able to communicate with server 106, the receiving device may transmit or forward offline delegation request 112 to the server, either directly or indirectly, such as via network 108. In an example, if offline delegation request 112 is not already encrypted (e.g., by delegating device 102), receiving device 104 may encrypt the offline delegation request prior to transmitting the offline delegation request to server 106. In other examples, however, offline delegation request 112 may be transmitted to server 106 unencrypted, e.g., in plain text, depending on the privacy protection desired or required. In an example, offline delegation request 112 may be encrypted using an attribute-based cryptography algorithm. However, any encryption or cryptography algorithm may be used for encrypting offline delegation request 112. In an example, offline delegation request 112 may be transmitted to server 106 using a secure messaging channel. As noted above, any method for creating a secure messaging channel may be used.

Server 106 may decrypt the received offline delegation request 112, if encrypted, and may validate the offline delegation request. Offline delegation request 112 may be validated by checking or validating the signature of the delegating device 102 corresponding to the offline delegation request. Server 106 may also verify that delegating device 102 has or owns the appropriate authorization rights and/or delegation rights to delegate authorization to the receiving device 104 or user of the receiving device identified by the identity or identifier of the receiving device or user of the receiving device included with offline delegation request 112. Server 106 may also apply any additional logic, parameters, or rules in validating the offline delegation request. For example, but not limited hereto, server 106 may ensure that the offline delegation request conforms to a rule defining, for example, a limit on the delegation requests that can be made by the delegating device 102, or a rule defining, for example, which operations corresponding to secure asset 110 can be delegated, etc.

In exchange for an appropriate and/or validated offline delegation request 112, server 106 may provide corresponding authorization data 114 to receiving device 104 directly or indirectly, such as via network 108. Authorization data 114 permits receiving device 104 or user of the receiving device to access secure asset 110. Authorization data 114 may comprise an authorization certificate or token. In an example, authorization data 114 is an authorization token comprising the identity or identifier of receiving device 104 or user of the receiving device, thereby binding the authorization data 114 to the receiving device or user of the receiving device. The authorization data, such as an authorization certificate or token, may additionally specify secure asset 110 and/or one or more operations that are authorized or permitted with respect to the secure asset. For example, in the case secure asset 110 is a physical asset, such as a door, turnstile, computer terminal, printer, or the like, the one or more operations that are permitted may include, but are not limited to, access through or permission to use the secure asset or the like. In another example, in the case secure asset 110 is a logical asset, such as a database, application, financial account, or the like, the one or more operations that are permitted may include but are not limited to access to the secure asset, view/read/write/modify permissions, deposit/withdrawal permissions, or the like. Authorization data 114, such as but not limited to the authorization token described above, may additionally comprise any other suitable or desirable information, depending on, for example, the application or authorization management system 100. Authorization data 114 may be digitally signed (e.g., using asymmetric cryptography) by server 106.

Authorization data 114 may be encrypted prior to transmitting to receiving device 104, or the authorization data may be transmitted to the receiving device unencrypted, e.g., in plain text, depending on the privacy protection desired or required. In an example, authorization data 114 may be encrypted using an attribute-based cryptography algorithm. However, any encryption or cryptography algorithm may be used for encrypting authorization data 114. In an example, authorization data 114 may be transmitted to receiving device 104 using a secure messaging channel, such as but not limited to a same secure messaging channel established between receiving device 104 and server 106 to transmit offline delegation request 112. As noted above, any method for creating a secure messaging channel may be used.

Once authorization data 114 is received by receiving device 104, it may be decrypted, if desired or required, and stored by the receiving device. Receiving device 104 may also store authorization data 114 in its encrypted form and decrypt the authorization data upon subsequent use thereof or at some other later time. Receiving device 104 may subsequently use authorization data 114 to prove authorization or permission to access secure asset 110, or otherwise prove authorization or permission to perform the one or more operations corresponding to the secure asset that are authorized by the authorization data.

In an example, a reader device or other terminal device 116 may be associated with and control access to secure asset 110. To prove authorization or permission for receiving device 104 or user of the receiving device to access secure asset 110, or otherwise prove authorization or permission to perform the one or more operations corresponding to the secure asset that are authorized by authorization data 114, receiving device 104 may transmit or be commanded to transmit, such as by the user of the receiving device, at least a portion of the authorization data to the reader or terminal device 116 associated with the secure asset. Authorization data 114 (or the at least a portion thereof), may be encrypted prior to transmitting to reader or terminal device 116, or the authorization data (or the at least a portion thereof) may be transmitted to the reader or terminal device unencrypted, e.g., in plain text, depending on the privacy protection desired or required. In an example, authorization data 114 (or the at least a portion thereof) may be encrypted using an attribute-based cryptography algorithm. However, any encryption or cryptography algorithm may be used for encrypting authorization data 114 (or the at least a portion thereof). In an example, any such authorization data 114 may be transmitted to reader or terminal device 116 using a secure messaging channel. As noted above, any method for creating a secure messaging channel may be used.

Reader or terminal device 116 may decrypt the received authorization data 114, if encrypted, and may authenticate or validate the receiving device 104 and/or authorization data. If validated, reader or terminal device 116 may permit receiving device 104 or user of the receiving device to access secure asset 110, or otherwise perform the one or more operations corresponding to the secure asset that are authorized by the authorization data. Reader or terminal device 116 can be a wireless device, in that the reader or terminal device may communicate with receiving device 104 via wireless technologies, such as radio frequency identification (RFID) or personal area network (PAN) technologies, such as the IEEE 802.15.1, Bluetooth, Bluetooth Low Energy (BLE), near field communications (NFC), ZigBee, GSM, CDMA, Wi-Fi, UWB, etc. Reader or terminal device 116 may also include a PIN pad, touch screen, fingerprint reader, magnetic stripe reader, chip reader, or other non-wireless input means for receiving credential or other information, such as a PIN or other secret code, biometric information such as a fingerprint, or information from a magnetic stripe card or chip card, for example. Reader or terminal device 116 may alternatively or additionally include any other capability or functionality. Reader or terminal device 116 can be a single, stand-alone device or the reader or terminal device can be a distributed system of local and/or remote components. For instance, in some examples, reader or terminal device 116 can include or be connected, by wire or wirelessly, to a control panel that may make or may share responsibilities for access control to secure asset 110. In some examples, reader or terminal device 116 can be connected to a wired or wireless network, such as network 108, and communicate with a remote system, such as a host server of an access control system (ACS). In such cases, the remote system may make or may share responsibilities for access control to secure asset 110.

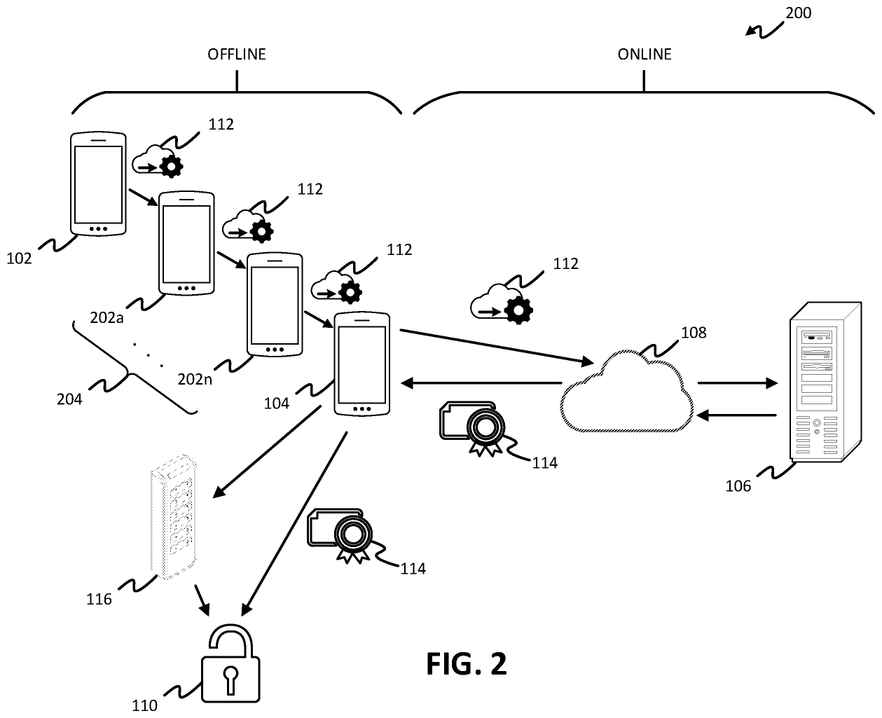

FIG. 2 illustrates a further example authorization management system 200 for offline delegation of authorization data. Delegating device 102, receiving device 104, server 106, network 108, secure asset 110, and reader or terminal device 116 are similar to those described above with respect to FIG. 1. In addition, example authorization management system 200 may include one or more intermediate devices 202a to 202n, which may each be, but need not be, a device of a user other than the user of delegating device 102 or the user of the receiving device 104. In general, intermediate device(s) 202a to 202n may act as forwarding devices to assist in getting offline delegation request 112 from delegating device 102 to receiving device 104, for example, but not limited to, when receiving device 104 is remote to delegating device 102. Accordingly, delegating device 102 and intermediate device(s) 202a to 202n form a chain 204 of intermediate devices, including up to n devices, as illustrated in FIG. 2.

More specifically, in the authorization management system 200 of FIG. 2, any or all of delegating device 102, intermediate device(s) 202a to 202n, or receiving device 104 may initially be “offline,” in that any or all of the delegating device, intermediate device(s), or receiving device are not in communication with, or do not desire to or are unable to communicate with, server 106 directly or indirectly, such as via network 108. Again, however, the user of delegating device 102 desires to delegate authorization to the user of receiving device 104 in order to permit the user of the receiving device to access secure asset 110.

Accordingly, in an example of offline delegation of authorization data herein, delegating device 102 may generate an offline delegation request 112 and transmit the offline delegation request to a first intermediate device, e.g., 202a. As previously described, offline delegation request 112 comprises an identity or identifier of receiving device 104 or user of the receiving device. The identity of receiving device 104 or user of the receiving device can be, for example, a public key of the receiving device or user of the receiving device. However, the identity of receiving device 104 or user of the receiving device may be any other suitable identifier of the receiving device or user of the receiving device, such as but not limited to, a public key certificate, which may be a public key signed by a certification authority. The identity of receiving device 104 or user of the receiving device binds offline delegation request 112 to the receiving device or user of the receiving device. Offline delegation request 112 may further include any other suitable or desirable information or data, such as but not limited to information or data indicating which secure asset 110 or secure assets the offline delegation request pertains to and/or which operation or operations corresponding to the secure asset(s) are requested to be delegated to receiving device 104 or user of the receiving device, etc. Offline delegation request 112 is digitally signed (e.g., using asymmetric cryptography) by delegating device 102. Because delegating device 102 or the user of the delegating device is known to server 106, the server can validate or trust any delegation request signed by the delegating device. Offline delegation request 112 may be encrypted and transmitted to receiving device 104, or the offline delegation request may be transmitted to the receiving device unencrypted, e.g., in plain text, depending on the privacy protection desired or required. As stated above, any encryption or cryptography algorithm may be used for encrypting offline delegation request 112. In an example, offline delegation request 112 may be transmitted to receiving device 104 using a secure messaging channel. As stated above, any method for creating a secure messaging channel may be used.

In some examples, first intermediate device 202a may be the only intermediate device, in which case the first intermediate device 202a may forward offline delegation request 112 to receiving device 104. Offline delegation request 112 may be encrypted and forwarded to receiving device 104, or the offline delegation request may be transmitted to the receiving device unencrypted, e.g., in plain text, depending on the privacy protection desired or required. As stated above, any encryption or cryptography algorithm may be used. In an example, offline delegation request 112 may be forwarded to receiving device 104 using a secure messaging channel. As stated above, any method for creating a secure messaging channel may be used.

In other examples, the first intermediate device 202a may forward offline delegation request 112 to a further intermediate device, which may be the final intermediate device, i.e., intermediate device 202n, in chain 204 or may be another intermediate device that may forward the offline delegation request to yet a further intermediate device, which may be the final intermediate device, i.e., intermediate device 202n, in the chain or yet another intermediate device, and so on. Ultimately, final intermediate device 202n may forward offline delegation request 112 to receiving device 104. In the case of each forwarded communication of offline delegation request 112, the offline delegation request 112 may be encrypted or unencrypted, e.g., in plain text, depending on the privacy protection desired or required. As stated above, any encryption or cryptography algorithm may be used. Likewise, in each case, offline delegation request 112 may be forwarded using a secure messaging channel. As stated above, any method for creating a secure messaging channel may be used.

Receiving device 104 then communicates with server 106 to, generally, exchange offline delegation request 112 for appropriate authorization data 114 required to access secure asset 110, as previously described. If at the time of receiving offline delegation request 112 from one of the intermediate devices 202a to 202n, receiving device 104 is offline or otherwise does not desire to or is unable to communicate with server 106 directly or indirectly, such as via network 108, the receiving device can wait to communicate with the server until the receiving device is online or otherwise able to communicate with the server directly or indirectly, such as via network 108. Authorization data 114 and its use are similar to that described above with respect to FIG. 1.

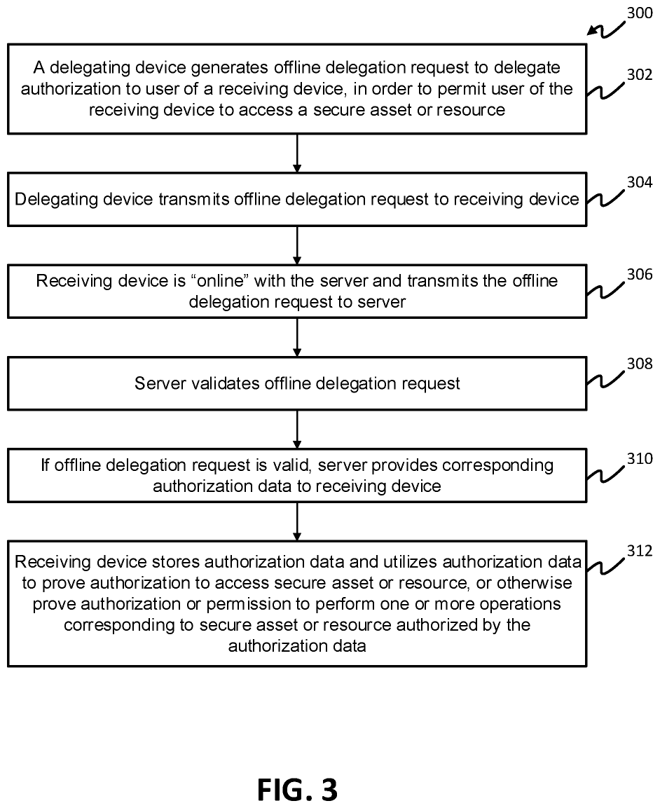

FIG. 3 is a flow chart generally illustrating a method for offline delegation of authorization data 300 in an authorization management system 100, 200, according to examples described herein. In step 302 of the method 300, a delegating device, e.g., delegating device 102, may generate an offline delegation request, e.g., offline delegation request 112, to delegate authorization to the user of a receiving device, e.g., receiving device 104, in order to permit the user of the receiving device to access a secure asset or resource, e.g., secure asset 110. In step 304, the delegating device transmits the offline delegation request to the receiving device. As described above, in some examples, there may be a chain comprising one or more intermediate devices, e.g., intermediate devices 202a to 202n, that generally forward the offline delegation request from the delegating device to the receiving device. During either or both of steps 302 and 304, any of the delegating device, intermediate device(s), and/or the receiving device may be “offline” from a server of the authorization management system, e.g., server 106, which among other things, receives requests for delegation of authorization, validates and/or approves such delegation requests, and provides the appropriate authorization data to corresponding delegated devices. In step 306, when the receiving device is “online” with the server, the receiving device transmits the offline delegation request to the server. In step 308, the server may validate the offline delegation request, as described herein. In step 310, in exchange for an appropriate and/or validated offline delegation request, the server may provide corresponding authorization data, e.g., authorization data 114, to the receiving device. Thereafter, in step 312, the receiving device may store the authorization data in memory thereof and may utilize the authorization data to prove authorization or permission to access the secure asset or resource, or otherwise prove authorization or permission to perform one or more operations corresponding to the secure asset or resource that are authorized by the authorization data, as described herein.

Although the flowchart of FIG. 3 illustrates an example method as comprising sequential steps or processes as having a particular order of operations, some or many of the steps or operations in the flowchart can be performed in parallel or concurrently, and the flowchart should be read in the context of the various example embodiments of the present disclosure. The order of the method steps or process operations illustrated in FIG. 3 may be rearranged for some embodiments. Similarly, the method illustrated in FIG. 3 could have additional steps or operations not included therein or fewer steps or operations than those shown.

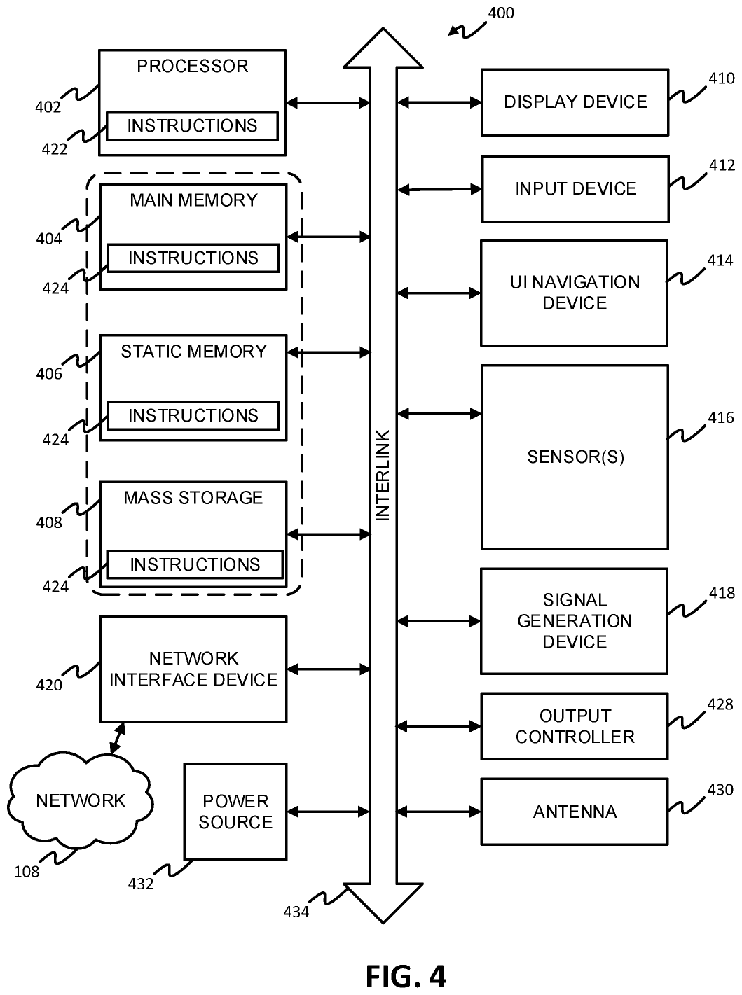

FIG. 4 illustrates a block diagram schematic of various example components of an example machine 400 that can be used as, for example, any of the various devices described herein, such as delegating device 102, intermediate device(s) 202a to 202n, receiving device 104, server 106, or reader or terminal device 116, and upon which a set or sequence of instructions may be executed to cause the machine to perform any one of, or any portion thereof, the methodologies described herein. Examples, as described herein, can generally include, or can operate by, logic or a number of components, modules, or mechanisms in machine 400. Modules may be hardware, software, or firmware communicatively coupled to one or more processors in order to carry out the operations described herein. Generally, circuitry (e.g., processing circuitry) of example machine 400 may include a collection of circuits implemented in tangible entities of the machine that include hardware (e.g., simple circuits, gates, logic, etc.). Circuitry membership can be flexible over time. Circuitries include members that can, alone or in combination, perform specified operations when operating. In some examples, hardware of the circuitry can be immutably designed to carry out a specific operation (e.g., hardwired). In some examples, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions permit embedded hardware (e.g., the execution units or a loading mechanism) to create members of the circuitry in hardware via the variable connections to carry out portions of the specific operation when in operation. Accordingly, in some examples, the machine readable medium elements are part of the circuitry or are communicatively coupled to the other components of the circuitry when the device is operating. In some examples, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional and/or more specific examples of components with respect to machine 400 follow.

In some embodiments, machine 400 can operate as a standalone device or can be connected (e.g., networked) to other machines. In a networked deployment, machine 400 can operate in the capacity of a server machine, a client machine, or both in server-client network environments. In some examples, machine 400 can act as a peer machine in a peer-to-peer (P2P) (or other distributed) network environment. Machine 400 can be or include a personal computer (PC), a tablet PC, a personal digital assistant (PDA), a mobile telephone, a web appliance, a network router, switch or bridge, a set-top box (STB), an RFID card or fob, smartcard, or any electronic device that may store an access credential that provides controlled access to a secure asset or resource, or generally any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., mobile device or computer system) 400 can include a hardware processor 402 (e.g., a central processing unit (CPU), a graphics processing unit (GPU), a hardware processor core, or any combination thereof) and a main memory 404, a static memory (e.g., memory or storage for firmware, microcode, a basic-input-output (BIOS), unified extensible firmware interface (UEFI), etc.) 406, and/or mass storage 408 (e.g., hard drives, tape drives, flash storage, or other block devices) some or all of which can communicate with each other via an interlink (e.g., bus) 434. Machine 400 can further include a display device 410, an input device 412, and/or a user interface (UI) navigation device 414. Examples of suitable display devices include, without limitation, one or more LEDs, a LCD panel, a display screen, a touchscreen, one or more lights, etc. Example input devices and UI navigation devices include, without limitation, one or more buttons, a keyboard, a touch-sensitive surface, a stylus, a camera, a microphone, etc. In some examples, one or more of the display device 410, input device 412, and/or UI navigation device 414 can be a combined unit, such as a touch screen display. Machine 400 can additionally include a signal generation device 418 (e.g., a speaker), a network interface device 420, one or more antennas 430, a power source 432, and one or more sensors 416, such as a global positioning system (GPS) sensor, compass, accelerometer, or other sensor. Machine 400 can include an output controller 428, such as a serial (e.g., universal serial bus (USB)), parallel, or other wired or wireless (e.g., infrared (IR), NFC, etc.) connection to communicate with or control one or more peripheral devices (e.g., a printer, card reader, etc.).

Processor 402 can correspond to one or more computer processing devices or resources. For instance, processor 402 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 402 can be provided as a microprocessor, Central Processing Unit (CPU), or plurality of microprocessors or CPUs that are configured to execute instructions sets stored in an internal memory 422 and/or memory 404, 406, 408.

Any of memory 404, 406, and 408 can be used in connection with the execution of application programming or instructions by processor 402 for performing any of the functionality or methods described herein, and for the temporary or long-term storage of program instructions or instruction sets 424 and/or other data for performing any of the functionality or methods described herein, such as offline delegation, or any portion thereof, as described herein. Any of memory 404, 406, 408 can comprise a computer readable medium that can be any medium that can contain, store, communicate, or transport data, program code, or instructions 424 for use by or in connection with machine 400. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or EEPROM), Dynamic RAM (DRAM), a solid-state storage device, in general, a compact disc read-only memory (CD-ROM), or other optical or magnetic storage device. Computer readable media includes, but is not to be confused with, computer readable storage medium, which is intended to cover all physical, non-transitory, or similar embodiments of computer readable media.

Network interface device 420 includes hardware to facilitate communications with other devices over a communication network, such as network 108, utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi or IEEE 802.16 family of standards known as WiMax), networks based on the IEEE 802.15.4 family of standards, and peer-to-peer (P2P) networks, among others. In some examples, network interface device 620 can include an Ethernet port or other physical jack, a Wi-Fi card, a Network Interface Card (NIC), a cellular interface (e.g., antenna, filters, and associated circuitry), or the like. In some examples, network interface device 620 can include one or more antennas to wirelessly communicate using, for example, at least one of single-input multiple-output (SIMO), multiple-input multiple-output (MIMO), or multiple-input single-output (MISO) techniques.

Antenna 430 can correspond to one or multiple antennas and can be configured to provide for wireless communications between, for example, any of the devices described herein, such as but not limited to, between delegating devices 102, between a delegating device and a receiving device 104, and/or between a receiving device and a reader or terminal device 116. Antenna(s) 430 can be arranged to operate using one or more wireless communication protocols and operating frequencies including, but not limited to, the IEEE 802.15.1, Bluetooth, Bluetooth Low Energy (BLE), near field communications (NFC), ZigBee, GSM, CDMA, Wi-Fi, RF, UWB, and the like. By way of example, antenna(s) 430 can be RF antenna(s), and as such, may transmit/receive RF signals through free-space to be received/transferred by another device having an RF transceiver.

Power source 432 can be any suitable internal power source, such as a battery, capacitive power source or similar type of charge-storage device, etc., and/or can include one or more power conversion circuits suitable to convert external power into suitable power (e.g., conversion of externally-supplied AC power into DC power) for components of the machine 400. Power source 432 can also include some implementation of surge protection circuitry to protect the components of machine 400 from power surges.

As indicated above, machine 400 can include one or more interlinks or buses 434 operable to transmit communications between the various hardware components of the machine. A system bus 434 can be any of several types of commercially available bus structures or bus architectures.

Although various example components of an example machine 400 are described and illustrated, not all components are required in each machine or device described herein and no machine or device described herein is limited to including just the example components described and illustrated herein. For example, any of the various devices described herein, such as delegating device(s) 102, receiving device 104, server 106, or reader or terminal device 116, may comprise a different set and/or combination of the example components and/or other components than another of the various devices described herein, e.g., another of the delegating device(s) 102, receiving device 104, server 106, or reader or terminal device 116.

### ADDITIONAL EXAMPLES

Example 1 includes subject matter (such as a method) for offline delegation of authorization to access a secure asset. The subject matter comprises receiving an offline delegation request from a delegating device at a receiving device while the receiving device is not in communication with a server of an authorization management system, the offline delegation request indicating a delegation of authorization from the delegating device to the receiving device for access to a secure asset; after establishing communication with the server, transmitting the offline delegation request from the receiving device to the server; and receiving, at the receiving device, authorization data from the server in exchange for the offline delegation request, the authorization data permitting access to the secure asset by the receiving device; wherein the offline delegation request comprises an identity of the receiving device or user of the receiving device and is digitally signed by the delegating device.

In Example 2, the subject matter of Example 1 optionally includes establishing communication with the server via an at least partially wireless network.

In Example 3, the subject matter of either Example 1 or Example 2 optionally includes wherein the offline delegation request further comprises data indicating the secure asset for which access authorization is to be delegated to the receiving device.

In Example 4, the subject matter of any of Examples 1 to 3 optionally includes wherein the offline delegation request is received at the receiving device encrypted.

In Example 5, the subject matter of Example 4 optionally includes wherein transmitting the offline delegation request from the receiving device to the server comprises transmitting the encrypted offline delegation request from the receiving device to the server.

In Example 6, the subject matter of any of Examples 1 to 5 optionally includes wherein the authorization data comprises an authorization token comprising the identity of the receiving device or user of the receiving device.

In Example 7, the subject matter of any of Examples 1 to 6 optionally includes transmitting at least a portion of the authentication data to at least one of the secure asset or a reader device associated with the secure asset to gain access to the secure asset.

In Example 8, the subject matter of any of Examples 1 to 7 optionally includes wherein the identity of the receiving device or user of the receiving device is at least one of a public key of the receiving device or a public key certificate from a certification authority.

In Example 9, the subject matter of any of Examples 1 to 8 optionally includes wherein the offline delegation request is received by the receiving device from the delegating device via one or more intermediate devices.

Example 10 includes subject matter (such as a method) for offline delegation of authorization to access a secure asset. The subject matter comprises receiving an offline delegation request from a receiving device at a server of an authorization management system, the offline delegation request having been received by the receiving device from a delegating device while the receiving device was offline from the server, wherein the offline delegation request comprises an identity of the receiving device or user of the receiving device and is digitally signed by the delegating device, and wherein the offline delegation request indicates a delegation of authorization from the delegating device to the receiving device for access to a secure asset; validating the offline delegation request by validating the signature of the delegating device; and if the signature of the delegating device is valid, transmitting authorization data from the server to the receiving device, the authorization data permitting access to the secure asset by the receiving device.

In Example 11, the subject matter of Example 10 optionally includes wherein the identity of the delegating device and at least some delegation rights owned by the delegating device are known to the server.

In Example 12, the subject matter of either Example 10 or Example 11 optionally includes wherein the offline delegation request further comprises data indicating the secure asset for which access authorization is to be delegated to the receiving device.

In Example 13, the subject matter of any of Examples 10 to 12 optionally includes wherein the offline delegation request further comprises data indicating one or more operations corresponding to the secure asset for which authorization is to be delegated to the receiving device.

In Example 14, the subject matter of any of Examples 10 to 13 optionally includes wherein the offline delegation request is received at the server encrypted.

In Example 15, the subject matter of Example 14 optionally includes wherein validating the offline delegation request further comprises decrypting the encrypted offline delegation request.

In Example 16, the subject matter of any of Examples 10 to 15 optionally includes wherein the authorization data comprises an authorization token comprising the identity of the receiving device or user of the receiving device.

In Example 17, the subject matter of any of Examples 10 to 16 optionally includes wherein the identity of the receiving device or user of the receiving device is at least one of a public key of the receiving device or a public key certificate from a certification authority.

In Example 18, the subject matter of any of Examples 10 to 17 optionally includes wherein the offline delegation request is received by the receiving device from the delegating device via one or more intermediate devices.

Example 19 includes subject matter relating to a non-transitory computer readable medium comprising executable program code, that when executed by one or more processors, causes the one or more processors to: receive an offline delegation request from a delegating device at a receiving device while the receiving device is not in communication with a server of an authorization management system, the offline delegation request indicating a delegation of authorization from the delegating device to the receiving device for access to a secure asset; after establishing communication with the server, transmit the offline delegation request from the receiving device to the server; and receive, at the receiving device, authorization data from the server in exchange for the offline delegation request, the authorization data permitting access to the secure asset by the receiving device; wherein the offline delegation request comprises an identity of the receiving device or user of the receiving device and is digitally signed by the delegating device.

In Example 20, the subject matter of Example 19 optionally includes wherein the offline delegation request is received at the receiving device encrypted, and wherein transmitting the offline delegation request from the receiving device to the server comprises transmitting the encrypted offline delegation request from the receiving device to the server.

In Example 21, the subject matter of Example 20 optionally includes wherein the authorization data comprises an authorization token comprising the identity of the receiving device or user of the receiving device, and wherein the executable program code causes the one or more processors to further transmit at least a portion of the authentication data to at least one of the secure asset or a reader device associated with the secure asset to gain access to the secure asset.

Example 22 includes subject matter (such as a method) for offline delegation of authorization to access a secure asset. The subject matter comprises generating an offline delegation request, the offline delegation request indicating a delegation of authorization from a delegating device to a receiving device for access to a secure asset; and transmitting the offline delegation request from the delegating device to the receiving device while the receiving device is not in communication with a server of an authorization management system; wherein the offline delegation request is exchangeable by the receiving device after establishing communication with the server for authorization data from the server, the authorization data permitting access to the secure asset by the receiving device; and wherein the offline delegation request comprises an identity of the receiving device or user of the receiving device and is digitally signed by the delegating device.

Example 23 includes subject matter relating to a non-transitory computer readable medium comprising executable program code, that when executed by one or more processors, causes the one or more processors to: generate an offline delegation request, the offline delegation request indicating a delegation of authorization from a delegating device to a receiving device for access to a secure asset; and transmit the offline delegation request from the delegating device to the receiving device while the receiving device is not in communication with a server of an authorization management system; wherein the offline delegation request is exchangeable by the receiving device after establishing communication with the server for authorization data from the server, the authorization data permitting access to the secure asset by the receiving device; and wherein the offline delegation request comprises an identity of the receiving device or user of the receiving device and is digitally signed by the delegating device.

Example 24 includes subject matter relating to a non-transitory computer readable medium comprising executable program code, that when executed by one or more processors, causes the one or more processors to: receive an offline delegation request from a receiving device at a server of an authorization management system, the offline delegation request having been received by the receiving device from a delegating device while the receiving device was offline from the server, wherein the offline delegation request comprises an identity of the receiving device or user of the receiving device and is digitally signed by the delegating device, and wherein the offline delegation request indicates a delegation of authorization from the delegating device to the receiving device for access to a secure asset; validate the offline delegation request by validating the signature of the delegating device; and if the signature of the delegating device is valid, transmit authorization data from the server to the receiving device, the authorization data permitting access to the secure asset by the receiving device.

Example 25 includes subject matter relating to an authorization management system. The system comprises a delegating device and a receiving device. The delegating device generates an offline delegation request and transmits the offline delegation request to the receiving device while the receiving device is not in communication with a server of the authorization management system, the offline delegation request indicating a delegation of authorization from the delegating device to the receiving device for access to a secure asset. After establishing communication with the server, the receiving device transmits the offline delegation request to the server in exchange for authorization data from the server, the authorization data permitting access to the secure asset by the receiving device. The offline delegation request comprises an identity of the receiving device or user of the receiving device and is digitally signed by the delegating device.

In Example 26, the subject matter of Example 25 optionally includes the server of the authorization management system. The server validates the offline delegation request from the receiving device by validating the signature of the delegating device, and if the signature of the delegating device is valid, transmits the authorization data to the receiving device.

### ADDITIONAL NOTES

The above detailed description includes references to the accompanying drawings, which form a part of the detailed description. The drawings show, by way of illustration, specific embodiments that can be practiced. These embodiments may also be referred to herein as “examples.” Such embodiments or examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. That is, the above-described embodiments or examples or one or more aspects, features, or elements thereof can be used in combination with each other.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure or portions thereof may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. In the context of this disclosure, a computer readable medium may be any medium that can contain, store, communicate, or transport the program for use by or in connection with the systems disclosed herein. As indicated above, the computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or EEPROM), a compact disc read-only memory (CD-ROM), or other optical, magnetic, or solid state storage device. As noted above, computer-readable media includes, but is not to be confused with, computer-readable storage medium, which is intended to cover all physical, non-transitory, or similar embodiments of computer-readable media.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A method for offline delegation of authorization to access a secure asset, the method comprising:
receiving an offline delegation request from a delegating device at a receiving device while the receiving device is not in communication with a server of an authorization management system, the offline delegation request indicating a delegation of authorization from the delegating device to the receiving device for access to a secure asset;
after establishing communication with the server, transmitting the offline delegation request from the receiving device to the server; and
receiving, at the receiving device, authorization data from the server in exchange for the offline delegation request, the authorization data permitting access to the secure asset by the receiving device;
wherein the offline delegation request comprises an identity of the receiving device or user of the receiving device and is digitally signed by the delegating device.

2. The method of claim 1, further comprising establishing communication with the server via an at least partially wireless network.

3. The method of claim 1, wherein the offline delegation request further comprises data indicating the secure asset for which access authorization is to be delegated to the receiving device.

4. The method of claim 1, wherein the offline delegation request is received at the receiving device encrypted.

5. The method of claim 4, wherein transmitting the offline delegation request from the receiving device to the server comprises transmitting the encrypted offline delegation request from the receiving device to the server.

6. The method of claim 1, wherein the authorization data comprises an authorization token comprising the identity of the receiving device or user of the receiving device.

7. The method of claim 1, further comprising transmitting at least a portion of the authentication data to at least one of the secure asset or a reader device associated with the secure asset to gain access to the secure asset.

8. The method of claim 1, wherein the identity of the receiving device or user of the receiving device is at least one of a public key of the receiving device or a public key certificate from a certification authority.

9. The method of claim 1, wherein the offline delegation request is received by the receiving device from the delegating device via one or more intermediate devices.

10. A method for offline delegation of authorization to access a secure asset, the method comprising:
receiving an offline delegation request from a receiving device at a server of an authorization management system, the offline delegation request having been received by the receiving device from a delegating device while the receiving device was offline from the server, wherein the offline delegation request comprises an identity of the receiving device or user of the receiving device and is digitally signed by the delegating device, and wherein the offline delegation request indicates a delegation of authorization from the delegating device to the receiving device for access to a secure asset;
validating the offline delegation request by validating the signature of the delegating device; and
if the signature of the delegating device is valid, transmitting authorization data from the server to the receiving device, the authorization data permitting access to the secure asset by the receiving device.

11. The method of claim 10, wherein the identity of the delegating device and at least some delegation rights owned by the delegating device are known to the server.

12. The method of claim 10, wherein the offline delegation request further comprises data indicating the secure asset for which access authorization is to be delegated to the receiving device.

13. The method of claim 10, wherein the offline delegation request further comprises data indicating one or more operations corresponding to the secure asset for which authorization is to be delegated to the receiving device.

14. The method of claim 10, wherein the offline delegation request is received at the server encrypted.

15. The method of claim 14, wherein validating the offline delegation request further comprises decrypting the encrypted offline delegation request.

16. The method of claim 10, wherein the authorization data comprises an authorization token comprising the identity of the receiving device or user of the receiving device.

17. The method of claim 10, wherein the identity of the receiving device or user of the receiving device is at least one of a public key of the receiving device or a public key certificate from a certification authority.

18. A non-transitory computer readable medium comprising executable program code, that when executed by one or more processors, causes the one or more processors to:
receive an offline delegation request from a delegating device at a receiving device while the receiving device is not in communication with a server of an authorization management system, the offline delegation request indicating a delegation of authorization from the delegating device to the receiving device for access to a secure asset;
after establishing communication with the server, transmit the offline delegation request from the receiving device to the server; and
receive, at the receiving device, authorization data from the server in exchange for the offline delegation request, the authorization data permitting access to the secure asset by the receiving device;
wherein the offline delegation request comprises an identity of the receiving device or user of the receiving device and is digitally signed by the delegating device.

19. The non-transitory computer readable medium of claim 18, wherein the offline delegation request is received at the receiving device encrypted, and wherein transmitting the offline delegation request from the receiving device to the server comprises transmitting the encrypted offline delegation request from the receiving device to the server.

20. The non-transitory computer readable medium of claim 18, wherein the authorization data comprises an authorization token comprising the identity of the receiving device or user of the receiving device, and wherein the executable program code causes the one or more processors to further transmit at least a portion of the authentication data to at least one of the secure asset or a reader device associated with the secure asset to gain access to the secure asset.
